(19) United States
(12) Patent Application Publication
(10) Pub. No.: US 2016/0284341 A1
(43) Pub. Date: Sep. 29, 2016

(54) COMPUTER-IMPLEMENTED METHOD, DEVICE AND SYSTEM FOR CONVERTING TEXT DATA INTO SPEECH DATA

(71) Applicants: Takahiro HIRAKAWA, London (GB); Yusaku MASUDA, Tokyo (JP); Christian RAVEL, London (GB); Loic BEYLOT, London (GB)

(72) Inventors: Takahiro HIRAKAWA, London (GB); Yusaku MASUDA, Tokyo (JP); Christian RAVEL, London (GB); Loic BEYLOT, London (GB)

(21) Appl. No.: 15/078,523

(22) Filed: Mar. 23, 2016

(30) Foreign Application Priority Data
Mar. 27, 2015 (EP) 15161466.6

(51) Int. Cl. G10L 13/04; G10L 13/027; G10L 25/72

(52) U.S. Cl. CPC G10L 13/043; G10L 25/72; G10L 13/027

(57) ABSTRACT

A computer-implemented method allows text data extracted from a scanned document by OCR to be converted into speech data such that the size of the speech data is equal to or lower than a predetermined speech data size limit. The method includes obtaining a predetermined speech data size limit; determining whether or not converting the text data into speech data will produce speech data with a size greater than the speech data size limit; and converting the text data into speech data such that the size of the speech data is equal to or lower than the speech data size limit. The speech data, optionally with at least one of the scanned document image and the text data, is then transmitted to a particular location.

### CROSS-REFERENCE TO RELATED APPLICATION

The present application is based upon and claims the benefit of priority of European patent application No. 15161466.6, filed on Mar. 27, 2015, the contents of which are incorporated herein by reference in their entirety.

### BACKGROUND OF THE INVENTION

1. Field of the Invention

The present invention relates to a computer-implemented method, device and system for converting text data into speech data.

2. Description of the Related Art

Text-to-speech technology enables text data to be converted into synthesized speech data. An example of such technology is the BrightVoice technology developed by IVONA Software of Gdansk, Poland.

One use of text-to-speech technology is disclosed in EP 0 457 830 B1. This document describes a computer system that is able to receive and store graphical images from a remote facsimile machine. The system includes software for transforming graphical images of text into an ASCII encoded file, which is then converted into speech data. This allows the user to review incoming faxes from a remote telephone.

The inventors of the present invention have developed a use of text-to-speech technology that involves scanning a document, extracting the text from the document and converting the text to speech data (scan-to-voice). The speech data produced from the scanned document can then be sent (in the form of an audio file, for example) to a particular location by email or other methods via a network, or to external storage means such as an SD card or USB drive, for example. However, the size of speech data is typically large (approximately 3-5 MB per 1000 characters of text) and a problem arises in that a user may face difficulty in sending the data to a particular location. This is because email services usually limit the size of file attachments, and large speech data will increase network load and require more storage space on a server or other storage means.

### SUMMARY OF THE INVENTION

It is an aim of the present invention to at least partially solve the above problem and provide more information and control over speech data produced from text data.

According to an embodiment of the present invention, there is provided a computer-implemented method for converting text data into speech data, the method including: obtaining a predetermined speech data size limit; determining whether or not converting the text data into speech data will produce speech data with a size greater than the speech data size limit; and converting the text data into speech data such that the size of the speech data is equal to or lower than the speech data size limit.

According to an embodiment of the present invention, there is provided a device for converting text data in speech data including: a processor configured to obtain a predetermined speech data size limit and determine whether or not converting text data into speech data will produce speech data with a size greater than the speech data size limit; and a text-to-speech controller configured to convert the text data into speech data such that the size of the speech data is equal to or lower than the speech data size limit.

According to an embodiment of the present invention, there is provided a system including: a scanner configured to scan a document to produce a scanned document image; a service configured to extract text data from the scanned document image; the above device for converting the text data into speech data; and a distribution controller configured to transmit the speech data, optionally with at least one of the scanned document image and the text data, to a particular location.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF THE DRAWINGS

Exemplary embodiments of the invention are described below with reference to the accompanying drawings.

FIG. 1 is a schematic drawing of a system according to an embodiment of the invention.

FIG. 2 is a diagram showing a process of converting a paper document into an audio file.

FIG. 3 is a schematic drawing of a user interface according to the invention.

FIG. 4 is a hardware block diagram related to the embodiment shown in FIG. 1.

FIG. 5 is a software module block diagram related to the system shown in FIG. 1.

FIG. 6 is a process diagram of a method according to an embodiment of the invention.

FIG. 7 is a schematic drawing of a user interface according to the invention.

FIG. 8 is a schematic drawing of a user interface according to the invention.

FIG. 9 is a schematic drawing of a system according to an embodiment of the invention.

FIG. 10 is a schematic drawing of a system according to an embodiment of the invention.

FIG. 11 is a hardware block diagram related to the system shown in FIG. 10.

FIG. 12 is a software block diagram related to the system shown in FIG. 10.

FIG. 13 is a process diagram of a method according to an embodiment of the invention.

FIG. 14 is a schematic drawing of a system according to an embodiment of the invention.

FIG. 15 is a hardware block diagram related to the system shown in FIG. 14.

FIG. 16 is a software block diagram related to the system shown in FIG. 14.

FIG. 17 is a process diagram of a method according to an embodiment of the invention.

FIG. 18 is a schematic drawing of a system according to an embodiment of the invention.

FIG. 19 is a software block diagram related to the system shown in FIG. 18.

FIG. 20 is a process diagram of a method according to an embodiment of the invention.

### DETAILED DESCRIPTION OF THE PREFERRED EMBODIMENTS

A description will be given of embodiments with reference to the accompanying drawings.

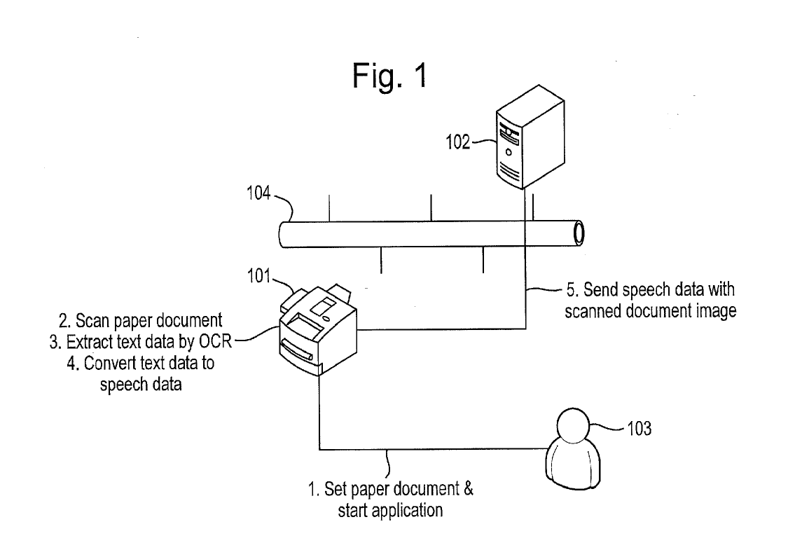

A system according to an embodiment of the invention is depicted in FIG. 1. Image processing device 101 is connected to a server 102 via a network 104. The image processing device 101 is in the form of a multifunction printer (MFP) and preferably comprises means for scanning a paper document 105, means for extracting text data 106 from the scanned document 105 and means for converting the text data into speech data 107. The server 102 is, for example, a document server for storing files or an SMTP server for sending email. The network 104 may be a conventional LAN or WLAN, or the Internet. A user 103 initiates the scanning of a paper document 105 at the image processing device 101. The image processing device 101 then produces an image 106 of the scanned document 105, extracts text data 107 from the scanned document image 106 and converts the text data 107 into speech data 108. The produced speech data 108 is sent with the scanned document image to the server 102 via the network 104.

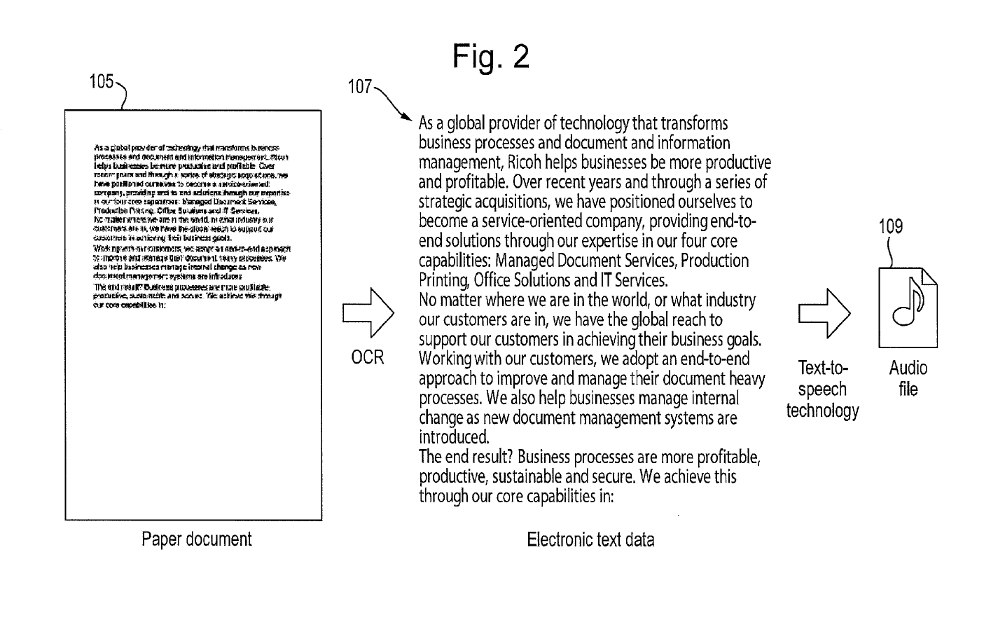

FIG. 2 illustrates how a paper document 105 can be converted into speech data 108. A paper document 105 is scanned to produce a digital scanned document image 106. The text in the scanned document image 106 is then extracted using known methods such as optical character recognition (OCR) and is converted into machine-encoded text data 107. The text data 107 is then analyzed and processed by a text-to-speech engine, which typically assigns phonetic transcriptions to each word in the text data 107 and converts the phonetic transcriptions into sounds that mimic speech (e.g. human speech) to 108 is conveniently output in the form of an audio file 109. The audio file 109 is not limited to a particular file format and may depend on the specification of the text-to-speech engine and/or the requirements of the user. The audio file may be outputted, for example, as one of the following formats: WAV (Waveform Audio File Format), MP3 (MPEG-1 or MPEG-2 Audio Layer III), MP4 (MPEG-4 Part 14) or AIFF (Audio Interchange File Format).

After converting the text data 107 into speech data 108, the speech data 108 may then be conveniently transmitted to a particular location. This includes sending the speech data 108 (e.g. in the form of an audio file 109) to a user or another recipient via email, storing the speech data 108 on a document server, or storing the speech data 108 on external storage means.

The speech data 108 may be transmitted on its own, but may also be transmitted together with the original scanned document image 106 and/or the text data 107 extracted from the scanned document image 106.

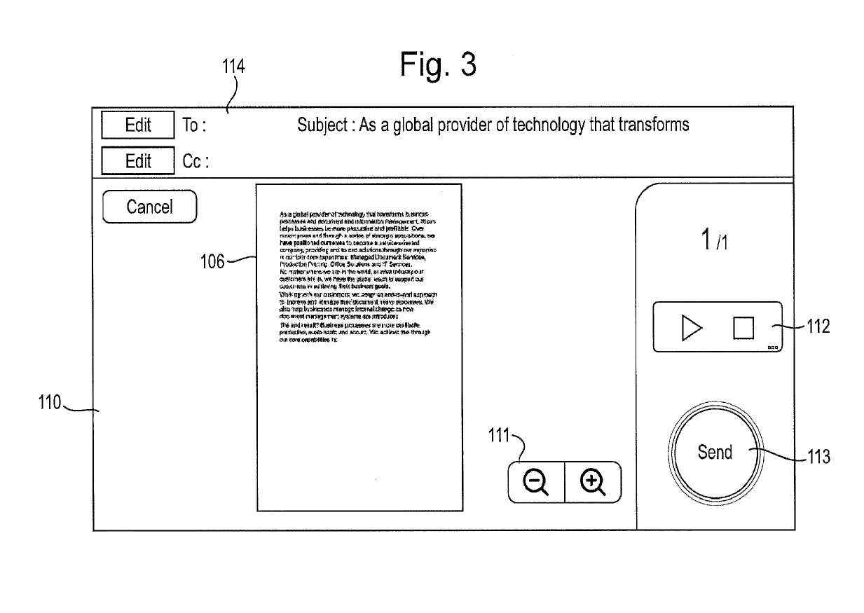

An example of an application for sending speech data 108 in the form of an audio file 109 produced from a scanned document 105 is shown schematically in FIG. 3. The application comprises a preview area 110 for displaying a scanned document image 106. Magnification control element 111 is provided for zooming the view of the scanned document image 106 in and out. Audio playback control element 112 is provided for playback of the audio file 109 produced from the scanned document 105. Audio playback control element 112 comprises a play button for starting playback and a stop button for stopping playback but may further comprise other playback controls such as a volume control and/or a seek bar. The graphical user interface of the application is arranged such that the user can play and listen to the audio file 109 at the same time as looking at the scanned document image 106. This allows the user 103 to confirm the accuracy of the produced speech data 108 before sending. A send control element 113 is provided for sending the scanned document image 106 together with the audio file 109 to a particular recipient. The application provides a recipient field 114 in which a user 103 can input a recipient's email address. Once the user selects the send control element 113, the scanned document image 106 and the audio file 109 are transmitted to the recipient's email address.

The present invention is not limited to transmitting the scanned document image 109 and/or the speech data 108 to a recipient via email. A user 103 may also transmit the scanned document image 109 and/or the speech data 108 to a recipient using another communication application, such as an instant messaging application that is capable of transferring files between the user 103 and the recipient. Furthermore, any combination of the scanned document image 106, the text data 107 and the speech data 108 can be sent to the recipient.

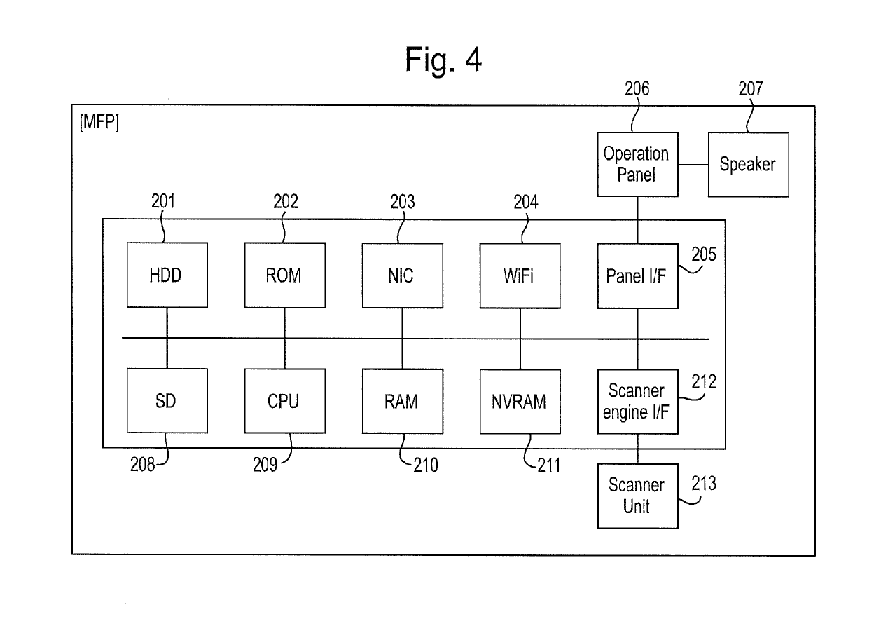

FIG. 4 depicts a hardware block diagram of the image processing device 101. The image processing device 101 comprises a hard disc drive 201 for storing applications and configuration data; ROM 202; a network interface controller (NIC) 203 for communicating with the server 102 via the network 104; a Wi-Fi card 204 for connecting wirelessly with the network 104 or other devices; an operation panel interface 205 and an operation panel 206, which allow the user 103 to interact with and pass instructions to the image processing device 101; a speaker 207, which allows the user 103 to hear playback of the speech data at the image processing device 101; an SD drive 208; a CPU 209 for carrying out instructions; RAM 210; NVRAM 211; and scanner engine interface 212 and scanner unit 213 for scanning a paper document.

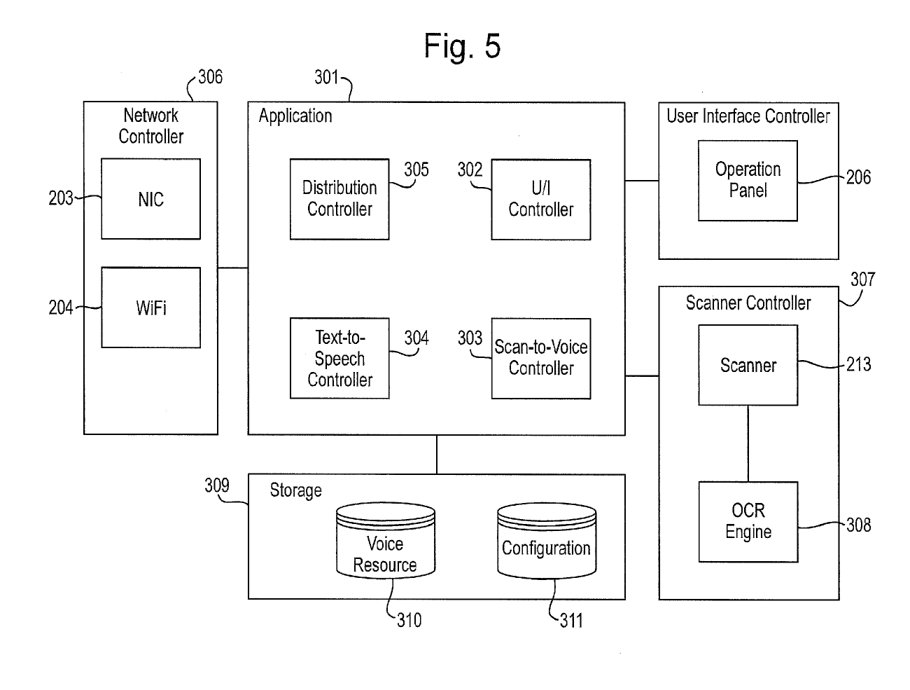

FIG. 5 depicts a software module block diagram of the image processing device 101. The image processing device 101 comprises an application 301. The application 301 comprises a UI controller 302, which controls the user interface on the operation panel 206; a scan-to-voice controller 303; a text-to-speech controller 304, which controls the conversion of text data 107 to speech data 108 through a text-to-speech engine; and a distribution controller 305, which controls the transmission of the scanned document image 106, text data 107 and/or speech data 108 to a particular location. The application 301 interacts with a network controller 306 for controlling the NIC 203 and the Wi-Fi card 204, and interacts with a scanner controller 307 for controlling the scanner unit 213 and an OCR engine 308. The application 301 further comprises storage 309 containing voice resources 310 for the text-to-speech engine and configuration data 311.

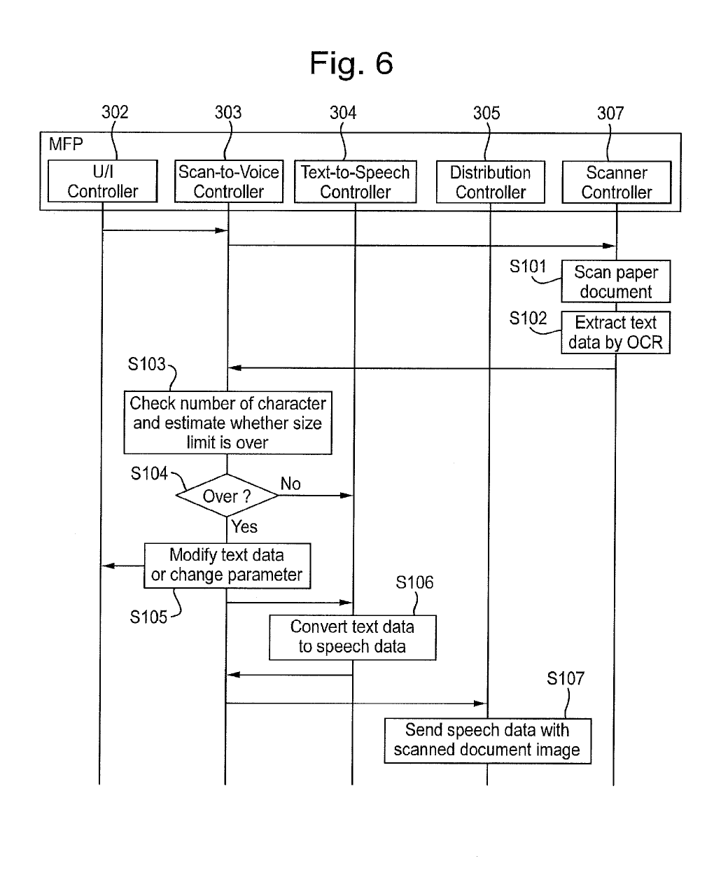

A method according to the present invention is depicted as a process diagram in FIG. 6. A user 103 requests scanning of a paper document using an operation panel of an image processing device 101. The UI controller 302 passes the user's request to the scan-to-voice controller 303, which requests the scanner controller 307 to scan the paper document to produce a scanned document image 106 (step S101). The scanner controller 307 then extracts text from the scanned document image 106 to produce machine-encoded text data 107 using the OCR engine 308 (step S102).

In step S103, the scan-to-voice controller 307 determines whether or not converting the extracted text data 107 into speech data 108 will produce speech data 108 with a size greater than a predetermined speech data size limit 115 (step S103). The predetermined speech data size limit 115 may be manually set by the user 103 or system administrator. If a speech data size limit 115 is not manually set, then a default value may be automatically set by the application 301. The user 103 may change the speech data size limit 115 as and when required, by changing the value of the speech data size limit 115 in a settings menu of the application 301, or by setting a speech data size limit 115 at the beginning of a scanning job.

There are multiple different approaches to determining whether or not converting the extracted text data 107 into speech data 108 will produce speech data 108 with a size greater than a predetermined speech data size limit 115, which are discussed below.

Table 1 shows an example of some parameters that are stored in the application. For a specified language and speech speed, the length of time required for a voice generated by the text-to-speech engine to speak a specified number of a type of text unit is stored as a speech duration parameter. The term “type of text unit” encompasses characters, words and paragraphs. The term “characters” includes at least one of the following: letters of an alphabet (such as the Latin or Cyrillic alphabet), Japanese hiragana and katakana, Chinese characters (hanzi), numerical digits, punctuation marks and whitespace. Some types of characters such as punctuation marks are not necessarily voiced in the same way as letters, for example, and therefore some types of characters may be chosen not to count as a character. In Table 1, and the following examples, the type of text unit that will be used is characters.

TABLE 1

| | | | Speech duration of |
|---|---|---|---|
| | Speech | Number of | number of characters |
| Language | speed | characters | (seconds) |
| English | Slow | 1000 | 90 |
| English | Normal | 1000 | 60 |
| English | Fast | 1000 | 40 |
| French | Normal | 1000 | 60 |
| Japanese | Normal | 1000 | 90 |

In an embodiment of the present invention, the determining step S103 comprises estimating the size of speech data 108 that would be produced by converting text data 107.

In an example of the present embodiment, the text data 107 contains 1500 characters and the text-to-speech engine is set to the English language at normal speed. The text-to-speech engine is also set to output the speech data 108 as a WAV file (44.1 kHz sample rate, 16 bits per sample, stereo). Using the parameters in Table 1, the speech duration of the generated voice can be estimated in the following manner:

$$estimated speech duration ( s ) = \frac{1500}{1000} \times 60 = 90 s$$

An estimated file size of the output WAV file can then be determined based on the data rate (kB/s) of the WAV file and the estimated speech duration as follows:

$$estimated file size ( kB ) = 44.1 \times \frac{16 \times 2}{8} \times 90 \approx 15900 kB$$

The estimated file size can then be compared to the predetermined speech data size limit 115. If the estimated file size is greater than the speech data size limit 115, step S103 determines that converting text data 107 would result in speech data 108 having a size greater than that of the predetermined speech data size limit 115.

In an alternative embodiment, the determining step 103 comprises estimating the number of characters that can be converted into speech data 108 within the predetermined size limit 115.

The estimated number of characters that can be converted to speech data 108 within the speech data size limit 115 can be determined based on an estimated speech duration per character and the duration of a WAV file with a file size equal to the speech data size limit 115.

In an example of the present embodiment, the text-to-speech engine is set to the English language at normal speed and is set to output the speech data 108 as a WAV file (44.1 kHz sample rate, 16 bits per sample, stereo). The speech data size limit 115 has been set as 3 MB. The estimated number of characters that can be converted to speech data 108 within the speech data size limit 115 can be calculated in the following manner:

$$estimated no . of characters = \frac{1000}{60} \times \frac{3 \times {10}^{6}}{44100 \times \frac{16 \times 2}{8}} \approx 283 characters$$

The estimated number of characters can then be compared to the actual number of characters in the text data 107 extracted from the scanned document image 106. If the estimated number of characters is less than the actual number of characters, then step 103 determines that converting text data 107 would result in speech data 108 having a size greater than that of the predetermined speech data size limit 115.

The present invention is not limited to using regular types of text units (e.g. characters, words, paragraphs) to determine whether or not converting the text data into speech data will produce speech data with a size greater than the speech data size limit. For example, a text buffer size may be used instead, with an associated speech duration.

The calculations described above may be performed in real time by the application 301.

Alternatively, the calculations may be performed in advance and the results stored in a lookup table. For example, estimated file sizes can be stored in association with particular numbers of characters or ranges of numbers of characters. For a given number of characters, an estimated file size can be retrieved from the lookup table.

In step S104, if it was determined in step S103 that converting the text data 107 would result in speech data 108 having a size greater than that of the predetermined speech data size limit 115, then the method proceeds to step S105.

If it was instead determined in step S103 that converting text data 107 would result in speech data 108 under the speech data size limit 115, then step S104 proceeds to step S106 without carrying out step S105.

In step S105, the text data 107 extracted from the scanned document image 106 may be modified such that the text-to-speech engine produces speech data 108 with a size equal to or lower the speech data size limit 115.

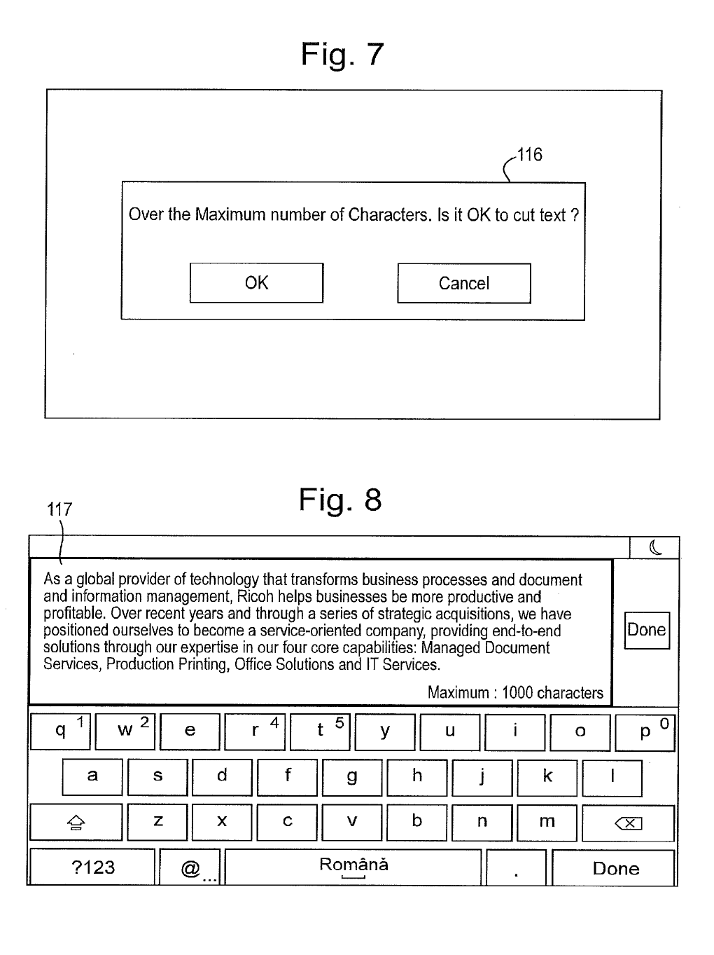

In one embodiment, the user 103 is shown an alert 116 on the user interface that informs the user 103 that the text data 107 will result in speech data 108 over the predetermined speech data size limit 115. FIG. 7 shows an example of an alert 116. The alert 116 is displayed as an alert box. In this particular example, the alert box displays a message informing the user 103 that the number of characters in the text data 107 is over the maximum number of characters. The term ‘maximum number of characters’ refers to the maximum number of characters than can be converted into speech data 108 within the speech data size limit 115. However, the exact message will depend on the method used to determine whether or not converting the text data 107 into speech data 108 will produce speech data 108 with a size greater than the speech data size limit 115. For example, if the step of determining was based on the number of words, rather than the number of characters, then the alert 116 may display a message informing the user 103 that the number of words is over the maximum number of words. The alert 115 may also show the user 103 the estimated size of the speech data 108 that will be produced by the text-to-speech engine.

The alert 116 shown in FIG. 7 also provides the user 103 with a choice to modify the text data 107 before the text-to-speech engine converts the text data 107 into speech data 108. In this particular example, the modification is to cut (reduce the size of) the text data 107. If the user 103 chooses to proceed with the modification, the application will automatically cut the text data 107 so that converting the modified text data 107 into speech data will result in speech data 108 with a size equal to or lower than the speech data size limit 115.

The application can automatically cut the text data 107 in variety of different ways. For example, the application may delete characters from the end of the text data until the text data 107 contains the maximum number of characters. Preferably, the application adjusts the cutting of the text data 107 so that the text data 107 ends at a whole word, rather than in the middle of a word. Other ways of modifying the text data 107 include deleting whole words, punctuation marks and abbreviating or contracting certain words. The application may also use a combination of different ways to cut the text data 107.

In another embodiment, the text data 107 may be modified by the user 103 before converting the text data 107 into speech data 108. FIG. 8 shows a user interface for the user 103 to modify the contents of the text data 107. This interface may be shown to the user 103 if the user 103 chooses to proceed with modifying the text after being shown the alert 116. The text data 107 is displayed as editable text 117 that the user can modify using the on-screen keyboard. However, the present invention is not limited to using an on-screen keyboard and the exact input method will depend on the device that the application is running on. To assist the user 103, the maximum number of characters or words is displayed on the screen. The interface preferably also displays the current number of characters or words in the text data 107.

In another embodiment, if it was determined in step S103 that converting the text data 107 would result in speech data 108 having a size greater than that of the predetermined speech data size limit 115, then the conversion produces speech data 108 as several files, each file having a size lower than the speech data size limit 115.

This is achieved by dividing the text data 107 into blocks before conversion, such that the conversion of each block will produce separate speech data files, each having a size lower than the speech data size limit 115. Division of the text data 107 into appropriate blocks is achieved by dividing the text data 107 such that each block contains a number of characters equal to or less than the maximum number of characters, for example.

The user 103 can choose to carry out this processing through an alert or prompt similar to alert 116, where the user 103 is provided with the option to divide the speech data 108 (by dividing the text data 107, as described above). If the user 103 chooses to proceed, then the application may carry out the dividing process automatically, or the user 103 may be presented with an interface that allows the user 103 to manually select how the text data 107 is divided into each block.

In a further embodiment, in step S105, a conversion parameter 118 of the text-to-speech engine is changed before converting the text data 107 into speech data 108. For example, a ‘speech sound quality’ parameter which determines the sound quality of the speech data produced by the text-to-speech engine can be changed to a lower quality to reduce the size of the speech data 108 produced from the text data 107. A ‘speech speed’ parameter of the text-to-speech engine could also be changed to allow more characters/words to be voiced as speech within the speech data size limit 115.

A parameter of the audio file 109 output by the text-to-speech engine, such as bitrate or sampling rate, or audio file format, may also be changed in order to produce an audio file with a lower size.

The application may change any of the conversion parameters 118 or audio file parameters automatically after alerting the user in a similar manner to alert 116. Alternatively, the user 103 may change a conversion parameter 118 manually, through a screen prompt, for example.

Once the text data 107 has been modified or a conversion parameter 118 has been changed so that speech data 109 produced by the text-to-speech engine will have a size equal to or lower than the speech data size limit, the method proceeds to step S106.

In step S106, the text data 107 is converted into speech data 108 having a size equal to or lower than the speech data size limit 115. The conversion is carried out using known text-to-speech technology. The text-to-speech engine is configurable by changing conversion parameters 118 such as speech sound quality and speech speed. The text-to-speech engine preferably outputs the speech data 108 as an audio file 109.

After the conversion of the text data 107 into speech data having a size equal to or lower than the speech data size limit 115, the method proceeds to step S107.

In step S107, the speech data 108 is transmitted with the scanned document image 106 to a particular location. The location and method of transmission is not limited and includes, for example, sending to a recipient via email, to a folder on a document server, to external memory (e.g. SD card or USB drive) etc. Furthermore, the invention is not limited to sending the speech data 108 with the scanned document image 106. Instead, the speech data 108 may be sent on its own, or with text data 107, or with both the text data 107 and the scanned document image 106.

For example, in the case of transmitting via email, the speech data 108, the scanned document image 106 and/or the text data 107 can be sent as separate files attached to the same email. In the case of storing on a document server, the speech data 108, the scanned document image 106 and/or the text data 107 can be saved together as separate files within the same folder or saved together in a single archive file. In addition, the files may be associated with one another using metadata. In a specific embodiment, the files are handled by an application which organizes the files together in a “digital binder” interface. An example of such an application is the gDoc Inspired Digital Binder software by Global Graphics Software Ltd of Cambridge, United Kingdom.

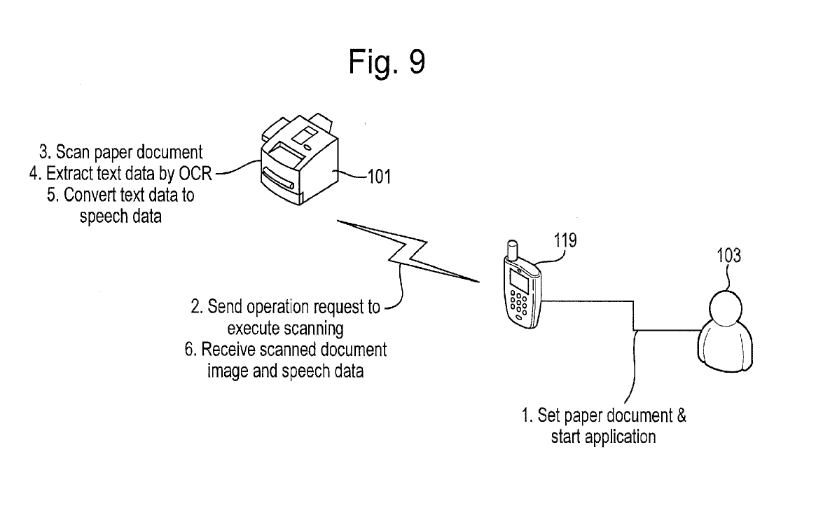

The present invention is not limited to the arrangement of the image processing device 101, server 102 and user 103 described thus far. FIG. 9 shows a system comprising an image processing device 101, a user 103 and a smart device 119 (such as a smart phone or a tablet computer). The smart device 119 is configured to send an operation request to the image processing device 101 to execute scanning. Steps S101-S107 are carried out in a similar manner to those already described for FIG. 6; however, at step S107, the speech data 108 and optionally at least of the scanned document image 106 and the text data 107 is transmitted to the smart device 119. The smart device 119 can connect to the image processing device 101 by Wi-Fi, Wi-Fi Direct (peer-to-peer Wi-Fi connection), Bluetooth or other communication means. The present embodiment is not limited to a smart device and the smart device 119 could be replaced with a personal computer or server.

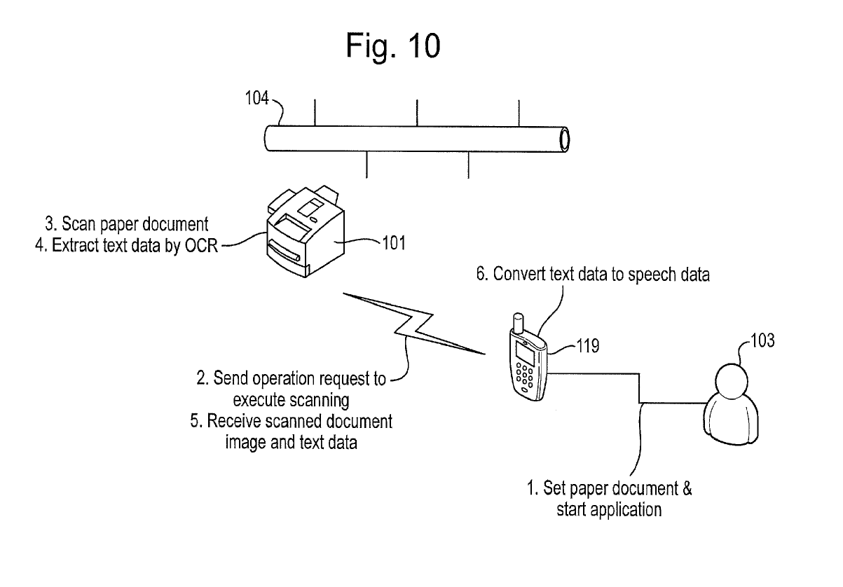

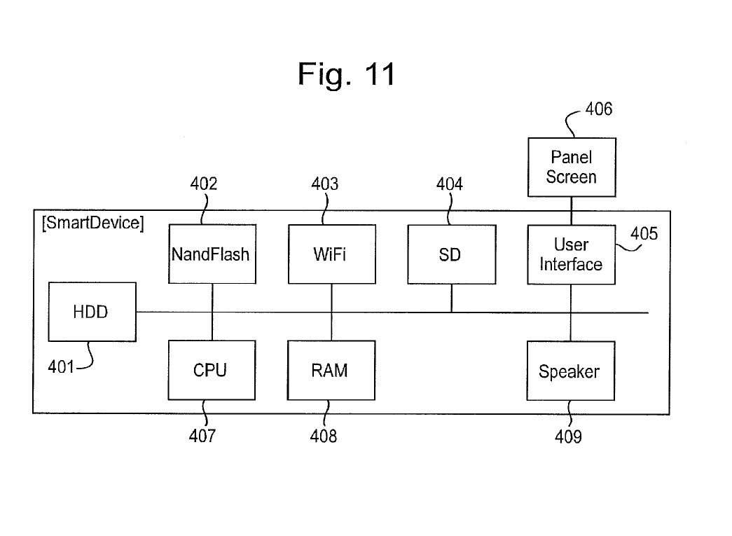

FIG. 10 depicts another system according to the present invention and comprises an image processing device 101, a user 103, a network 104 and a smart device 119 in an arrangement similar to that of FIG. 9. The smart device 119 is configured to send an operation request to the image processing device 101 to execute scanning.

FIG. 11 depicts a hardware block diagram of the smart device 119 according the present embodiment. The smart device 119 comprises a hard disc drive 401; NAND type flash memory 402; a Wi-Fi chip 403 for connecting wirelessly to the image processing device 101 and/or network 104; an SD drive 404; a user interface 405 and panel screen 406 for interacting with the smart device 119; a CPU 407 for carrying out instructions; RAM 408; and a speaker 409 to allow playback of the speech data 108 to be heard by the user 103.

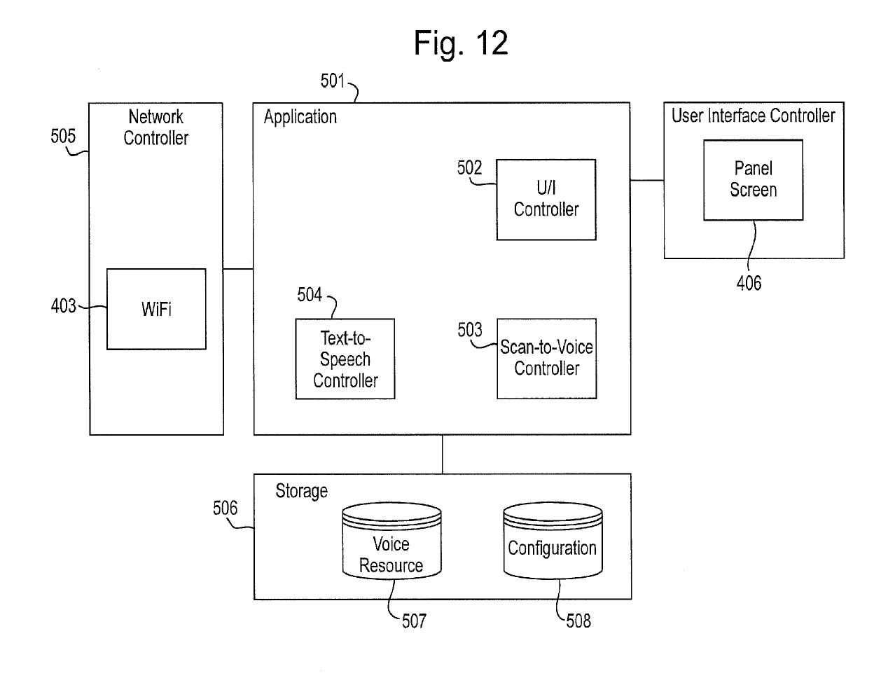

FIG. 12 depicts a software module block diagram of the smart device 119 according to the present embodiment. The smart device 119 comprises an application 501. The application 501 comprises a UI controller 502, which controls the user interface 405 on the operation panel 406; a scan-to-voice controller 503; and a text-to-speech controller 504, which controls the conversion of text data 107 to speech data 108 through a text-to-speech engine. The application 501 interacts with a network controller 505 for controlling the Wi-Fi chip 403. The application 501 further comprises storage 506 containing voice resources 507 for the text-to-speech engine and configuration data 508.

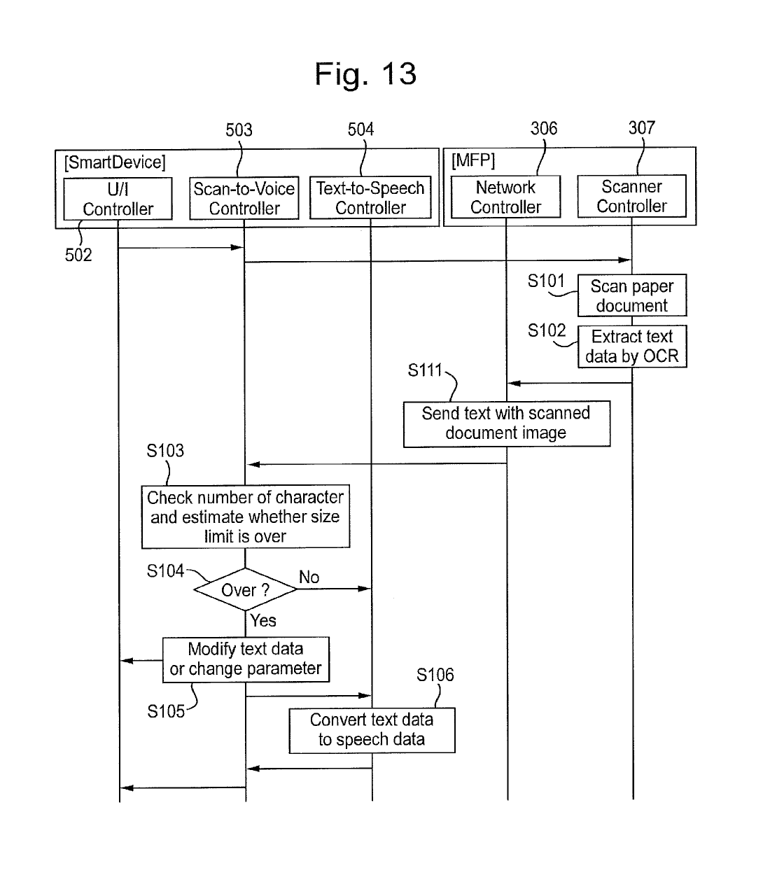

FIG. 13 depicts a method performed by the system shown in FIG. 10. Steps S101 and S102 are carried out at the image processing device 101 in a similar manner to those steps already described for FIG. 6. However, after scanning the paper document to obtain a scanned document image 106 and extracting the text data 107 by OCR (steps S101 and S102), the method proceeds to step Sill in which the scanned document image 106 and the text data 107 is sent to the smart device 119 via a network. The steps of determining whether or not converting the text data 107 into speech data 108 will produce speech data 108 with a size greater than the speech data size limit 115; optional modification of the text data 107 or changing of a conversion parameter 118; and conversion of the text data 107 and speech data 108 (steps S103-S106) are carried out on the smart device 119 instead of the image processing device 101. After step S106, the smart device will contain the scanned document image 106, the text data 107 and the speech data 108. The present embodiment is not limited to a smart device 119 and the smart device 119 could be replaced with a personal computer or server.

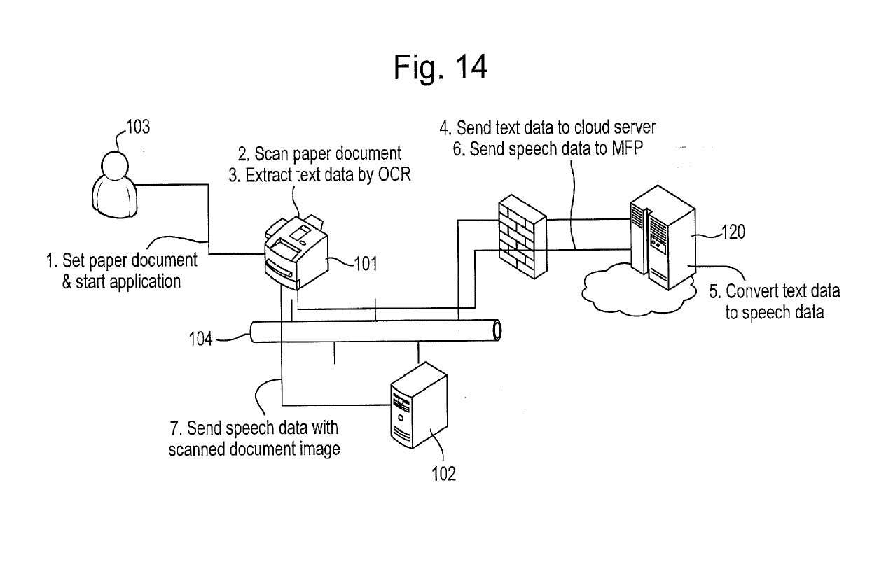

FIG. 14 depicts another system according to the present invention. The system comprises an image processing device 101, a server 102, a user 103, a network 104 and a remote server 120. Remote server 120 is configured to perform text-to-speech conversion.

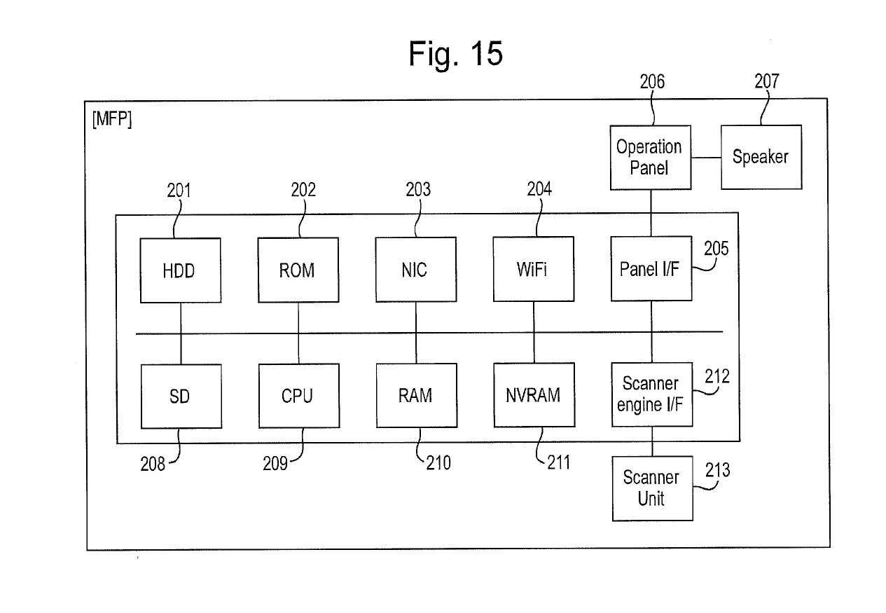

FIG. 15 depicts a hardware block diagram of the image processing device 101 according to the present embodiment. The image processing device 101 according to the present embodiment contains the same hardware as that depicted in above-described FIG. 4 and thus the hardware will not be described here again.

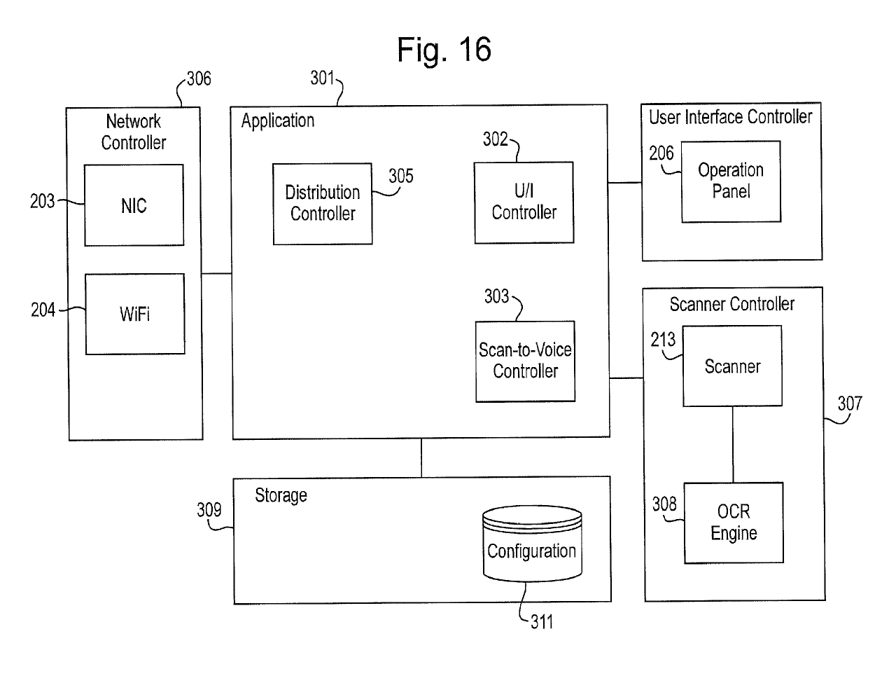

FIG. 16 depicts a software module block diagram of the image processing unit device 101 according to the present embodiment. Image processing device 101 according to the present embodiment contains the same software modules as those depicted in above-described FIG. 5, with the exception of the text-to-speech controller 304 and voice resources 310, which are not required as the text-to-speech conversion is performed by the remote server 120.

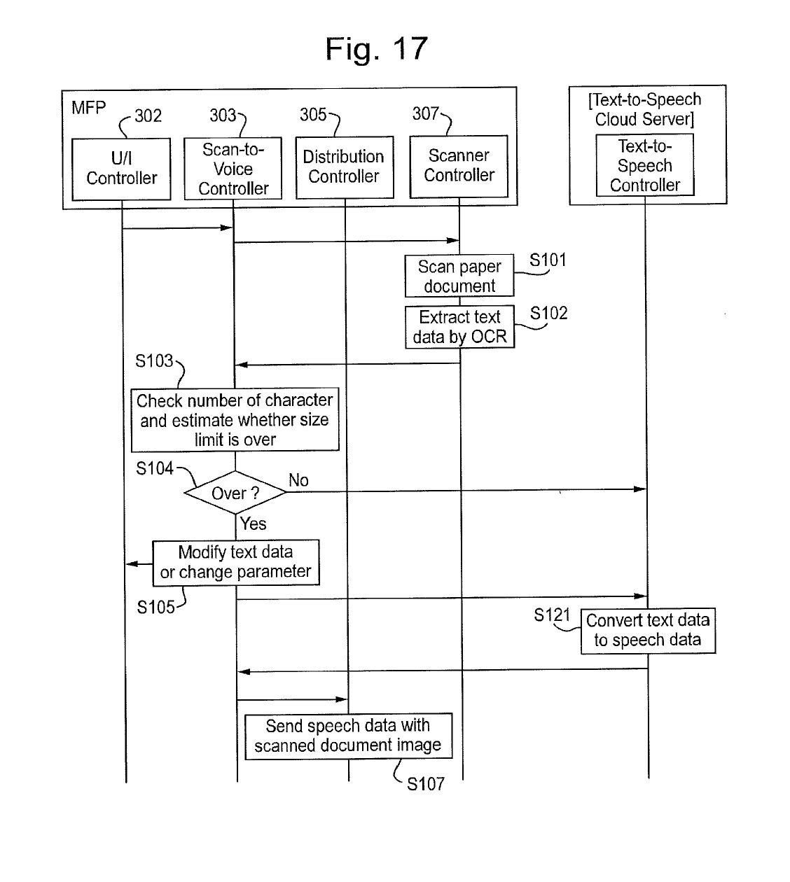

FIG. 17 depicts a method performed by the system shown in FIG. 14. Steps S101-S103 are carried out at the image processing device 101 in a similar manner to those steps already described for FIG. 6. However, after step S104 (if it is determined that the speech data 108 will not be over the speech data size limit 115), or after step S105 (if it was determined that the speech data 108 will be over the speech data size limit 115), the method proceeds to step S121. Instead of the text-to-speech conversion being carried out on the image processing device, the text data 107 is sent to remote server 120 for preforming the text-to-speech conversion. After the conversion is complete, the remote server 120 then sends the speech data back to the image processing device 101, which proceeds to carry out step S107. In this way, the text-to-speech processing can be handled by a central dedicated server, which can handle conversions more quickly and efficiently and from multiple image processing devices 101 at once.

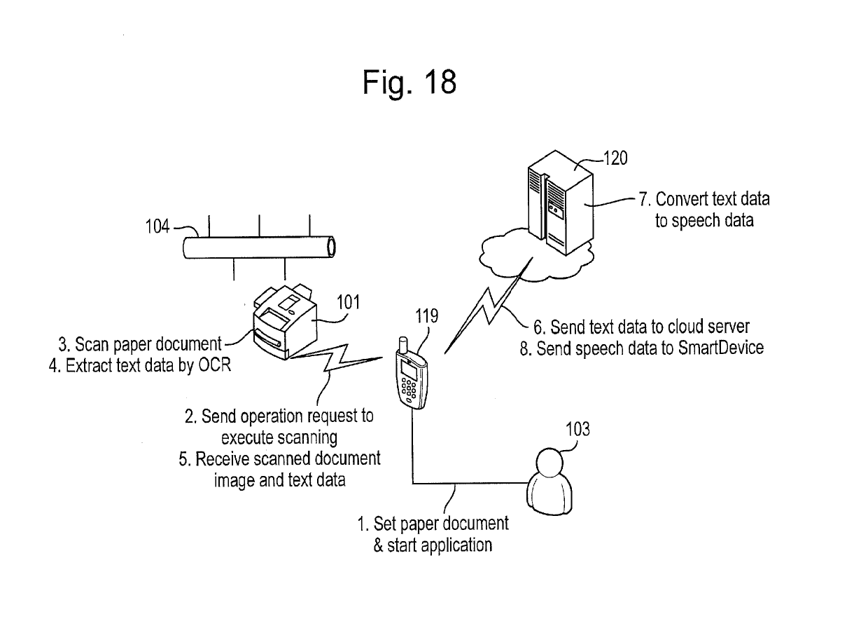

FIG. 18 depicts another system according to the present invention. The system is similar to the system depicted in FIG. 10 and comprises an image processing device 101, a user 103, a network 104, a smart device 119 and a remote server 120.

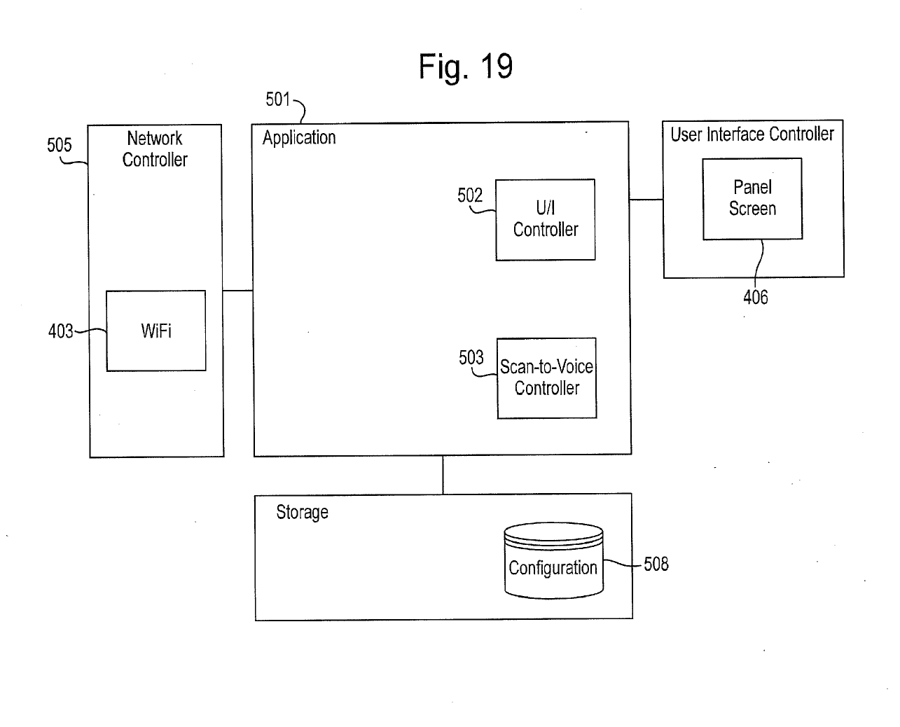

FIG. 19 depicts a software module block diagram of the smart device 119 according to the present embodiment. The smart device 119 according to the present embodiment contains the same software modules as those depicted in above-described FIG. 12, with the exception of the text-to-speech controller 504 and voice resources 507, which are not required as the text-to-speech conversion is performed by the remote server 120.

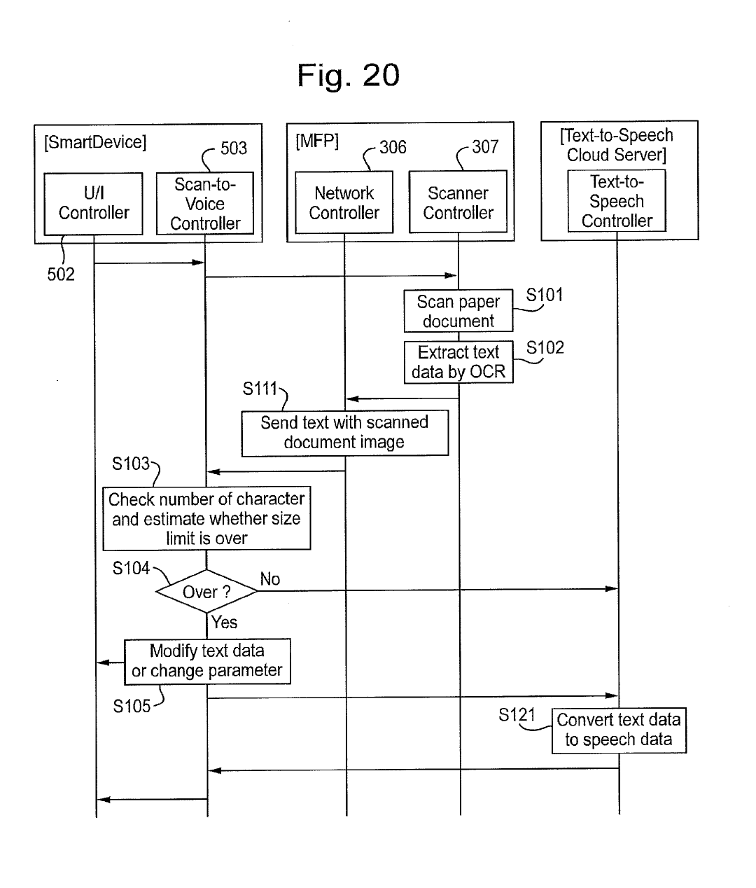

FIG. 20 depicts a method performed by the system shown in FIG. 18. Steps S101, S102 and S111 are carried out at the image processing device 101 in a similar manner to those steps already described for FIG. 13. However, after step S104 (if it is determined that the speech data 108 will not be over the speech data size limit 115), or after step S105 (if it was determined that the speech data 108 will be over the speech data size limit 115), the method proceeds to step S121 in which the text data 107 is sent to the remote server 120 to be converted into speech data. Thus, in this embodiment, the image processing device 101 carries out scanning of a paper document and performing OCR to extract text data 107; the smart device 119 determines whether or not the speech data 108 will have a size equal to or under the speech data size limit 115; and the text-to-speech conversion is performed on the remote server 120. After the conversion is complete, the remote server 120 then sends the speech data 108 back to the smart device 119. In this way, the text-to-speech processing can be handled by a central dedicated server, which can handle conversions more quickly and efficiently and from multiple image processing devices 101 at once.

Although in each of the above-described embodiments the extraction of text data 107 from the scanned image document 106 is performed by the image processing device 101, the text extraction could also be performed by an OCR engine at a remote server.

Furthermore, the smart device 119 may replace the image processing apparatus 101 for the steps of scanning and/or extraction of text data in any of the above described embodiments. For example, if the smart device 119 has a camera, an image 106 of a paper document 105 can be obtained and image processed to improve clarity if necessary (“scanning”) and then text data 107 may be extracted from the document image 106 using an OCR engine contained in the smart device 119.

The embodiments of the invention thus allow a speech data size limit 115 to be specified and text data 107 to be converted into speech data 108 such that the size of the speech data is equal to or lower than the speech data size limit 115. The user 103 therefore does not waste time waiting for a text-to-speech conversion that will produce speech data 108 that the user 103 cannot send.

In some embodiments of the invention the user 103 is also informed, in advance of a text-to-speech conversion, whether or not converting the text data 107 into speech data 108 will produce speech data 108 with a size greater than the speech data size limit 115. The user 103 is therefore provided with useful information relating to the size of the speech data 108 that will be produced.

Furthermore, some embodiments of the invention allow the text data 107 to be automatically modified so that a text-to-speech conversion of the text data 107 will result in speech data 108 with a size equal to or lower than the speech data size limit 115. The user 103 therefore is able to quickly and conveniently obtain speech data 108 with a size equal to or below the speech data size limit 115 from a paper document 105. The user 103 does not have to spend time inconveniently modifying and rescanning the paper document 105 itself to obtain speech data 108 with a size equal to or below the speech data size limit 115.

Other embodiments of the invention allow the text data 107 to be modified by the user 103 so that a text-to-speech conversion of the text data 107 will result in speech data 108 with a size equal to or lower than the speech data size limit 115. This conveniently gives the user 103 more control over the speech data 108 to be produced from the text data 107. The user 103 also does not have to spend time inconveniently modifying and rescanning the paper document 105 itself to obtain speech data 108 with a size equal to or below the speech data size limit 115.

Some embodiments of the invention allow separate speech data files to be produced from the text data 107, each file having a size equal to or below the speech data size limit 115. In this way, all of the text data 107 can be converted to speech data 108 in the same session without abandoning any of the text content.

Some embodiments of the invention also allow conversion parameters 118 to be changed automatically or manually by the user 103 before text-to-speech conversion takes place, so that a text-to-speech conversion of the text data 107 will result in speech data 108 with a size equal to or lower than the speech data size limit 115. This allows speech data 108 of a suitable size to be produced, without needing to modify the text data. This also provides similar advantages to those identified above, namely saving the user 103 time and providing convenience, as the user 103 does not have to modify and rescan the paper document 105 itself multiple times in order to obtain speech data 108 with a size equal to or below the speech data size limit 115.

Having described specific embodiments of the present invention, it will be appreciated that variations and modifications of the above-described embodiments can be made. The scope of the present invention is not to be limited by the above description but only by the terms of the appended claims.

What is claimed is:

1. A computer-implemented method for converting text data into speech data, the method comprising:
obtaining a predetermined speech data size limit;
determining whether or not converting the text data into speech data will produce speech data with a size greater than the speech data size limit; and
converting the text data into speech data such that the size of the speech data is equal to or lower than the speech data size limit.

2. The method according to claim 1, wherein the determining comprises:
estimating the size of speech data converted from the text data; and
comparing the estimated size of speech data with the speech data size limit.

3. The method according to claim 1, wherein the determining comprises:
estimating the number of a predetermined type of text unit that can be converted into speech data within the speech data size limit; and
comparing the estimated number of the predetermined type of text unit with the actual number of the predetermined type of text unit in the text data.

4. The method according to claim 2, wherein the estimating is based on the language of the text data and/or a speech speed and/or an average duration of speech for a specified number of a predetermined type of text unit.

5. The method according to claim 1, further comprising:
modifying the text data before converting the text data into speech data.

6. The method according to claim 5, wherein the text data is modified automatically.

7. The method according to claim 5, wherein the text data is modified by a user.

8. The method according to claim 1, wherein the type of text unit is one of the following:
characters, words or paragraphs.

9. The method according to claim 1, further comprising:
changing at least one conversion parameter before converting the text data into speech data.

10. The method according to claim 9, wherein the at least one conversion parameter is speech sound quality and/or speech speed.

11. The method according to claim 1, wherein the converting the text data into speech data produces a plurality of speech data files, each file having a size equal to or lower than the speech data size limit.

12. The method according to claim 1, wherein the text data is obtained from a scanned document image by optical character recognition OCR.

13. The method according to claim 1, further comprising:
transmitting the speech data, optionally with at least one of the scanned document and the text data, to a particular location.

14. A device for converting text data in speech data, comprising:
a processor configured to obtain a predetermined speech data size limit and determine whether or not converting text data into speech data will produce speech data with a size greater than the speech data size limit; and
a text-to-speech controller configured to convert the text data into speech data such that the size of the speech data is equal to or lower than the speech data size limit.

15. A system comprising:
a scanner configured to scan a document to produce a scanned document image;
a service configured to extract text data from the scanned document image;
the device for converting the text data into speech data according to claim 14; and
a distribution controller configured to transmit the speech data, optionally with at least one of the scanned document image and the text data, to a particular location.
